(19) United States
(12) Patent Application Publication
(10) Pub. No.: US 2014/0132850 A1
(43) Pub. Date: May 15, 2014

(54) PROJECTION IMAGE DISPLAY APPARATUS AND WAVEPLATE

(71) Applicant: ColorLink Japan, Ltd., Niigata (JP)

(72) Inventors: Sosuke OTANI, Nara (JP); Ken MASHITANI, Osaka (JP); Takaaki ABE, Osaka (JP); Makoto MAEDA, Nara (JP); Yoshitaka SATO, Kanagawa (JP)

(73) Assignee: COLORLINK JAPAN, LTD., Niigata (JP)

(21) Appl. No.: 14/157,521

(22) Filed: Jan. 17, 2014

Related U.S. Application Data
(63) Continuation of application No. PCT/JP2013/003775, filed on Jun. 17, 2013.

(30) Foreign Application Priority Data
Jun. 15, 2012 (JP) 2012-135727

(51) Int. Cl. G02B 5/32; G02B 27/22

(52) U.S. Cl. CPC G02B 5/32; G02B 27/2228
USPC 349/5; 359/489.07

(57) ABSTRACT

Provided is a projection image display apparatus that can restrict crosstalk between a left eye image and a right eye image. The projection image display apparatus includes a liquid crystal element that switches polarization of the light emitted from the optical modulation element between a first polarization and a second polarization, and a waveplate that is provided between the liquid crystal element and the projection surface. The waveplate includes a plurality of areas having different slow axes or fast axes from each other.

The contents of the following Japanese patent application and PCT application are incorporated herein by reference:

No. 2012-135727 filed on Jun. 15, 2012, and

No. PCT/JP2013/003775 filed on Jun. 17, 2013.

### BACKGROUND

1. Technical Field

The present invention relates to a projection image display apparatus including a light source, an optical modulation element that modulates light emitted from the light source, and a projection unit that projects the light modulated by the optical modulation element onto a projection surface. The present invention also relates to a waveplate.

2. Related Art

A conventional stereoscopic image is known that is formed by a plurality of viewpoint images, e.g. by a left eye image and a right eye image. Each viewpoint image is captured from a different viewpoint position, e.g. a viewpoint position of the left eye and a viewpoint position of the right eye, such as shown in Patent Document 1, for example.

A method using polarized light is known as a method for displaying the stereoscopic image, as shown in Patent Document 1, for example.

As an example, a left eye image (or right eye image) is output as light having a first polarization and a right eye image (or left eye image) is output as light having a second polarization. The viewer can see the stereoscopic image by wearing polarization glasses.

Patent Document 1: Japanese Patent Application Publication No. 2004-228743

However, the polarization state of the light that reaches the viewer decays due to the projection unit or screen.

This decay of the polarization state causes crosstalk between the left eye image and the right eye image.

### SUMMARY

Therefore, it is an object of an aspect of the innovations herein to provide projection image display apparatus, which is capable of overcoming the above problem by restricting crosstalk between a left eye image and a right eye image.

According to a first aspect of the present invention, provided is a projection image display apparatus that displays a stereoscopic image and comprises a light source, an optical modulation element that modulates light emitted from the light source, and a projection unit that projects the light modulated by the optical modulation element onto a projection surface, the projection image display apparatus further comprising a liquid crystal element that switches polarization of the light emitted from the optical modulation element between a first polarization and a second polarization; and a waveplate that is provided between the liquid crystal element and the projection surface. The waveplate includes a plurality of areas having different slow axes or fast axes from each other.

In the projection image display apparatus, the slow axes or fast axes have line symmetry with respect to a straight line passing through an optical axis center of the projection unit. The slow axes or fast axes have rotational symmetry with respect to a straight line passing through an optical axis center of the projection unit. The slow axes or fast axes are orthogonal to a straight line extending radially from an optical axis center of the projection unit. Retardation of the waveplate changes gradually according to distance from an optical axis center of the projection unit. Retardation of the waveplate increases gradually according to distance from an optical axis center of the projection unit.

According to a second aspect of the present invention, provided is a waveplate comprising a plurality of areas having different slow axes or fast axes from each other.

With the present invention, provided is a projection image display apparatus that can restrict crosstalk between a left eye image and a right eye image.

### BRIEF DESCRIPTION OF THE DRAWINGS

FIG. 1 shows the projection image display apparatus 100 according to the first embodiment.

FIG. 2 is used to describe the polarization state occurring when the waveplate 90 is not provided.

FIG. 3 is used to describe the waveplate 90 according to the first embodiment.

FIG. 4 shows an example of the projection image display apparatus 100 according to the first embodiment.

FIG. 5 shows an example of the projection image display apparatus 100 according to the first embodiment.

FIG. 6 shows an example of the projection image display apparatus 100 according to the first embodiment.

FIG. 7 is used to describe the waveplate 90X according to the first modification.

### DESCRIPTION OF EXEMPLARY EMBODIMENTS

Hereinafter, projection image display apparatuses will be described, with reference to the drawings, as embodiments of the present invention. Components in the drawings that are identical or similar to components in other drawings are given the same reference numerals.

### Outline of the Embodiments

The projection image display apparatus according to an embodiment of the present invention includes a light source, an optical modulation element that modulates light emitted from the light source, and a projection unit that projects the light modulated by the optical modulation element onto a projection surface, and displays a stereoscopic image. The projection image display apparatus includes a liquid crystal element that switches the polarization of the light emitted from the optical modulation element between a first polarization and a second polarization, and a waveplate that is provided between the liquid crystal element and the projection surface. The waveplate has a different fast axis or slow axis in each of a plurality of areas.

In the present embodiment, the waveplate provided between the liquid crystal element and the projection surface has a different fast axis or slow axis in each of a plurality of areas. Having a different fast axis or slow axis means that at least one of the fast axis and the slow axis is different. For example, having a different fast axis or slow axis may mean that the directions of the fast axis or slow axis are different in each area. As another example, having a different fast axis or slow axis may mean that each area has a different refractive index difference, which is the difference between the refractive index of the slow axis and the refractive index of the fast axis. As yet another example, having a different fast axis or slow axis may mean that each area has a different retardation, which is a function of the refractive index difference between the fast axis and the slow axis. Having a different retardation may mean that the refractive index difference between the fast axis and slow axis is different, or may mean that the distance travelled by the light passing through the waveplate is different in each area. Accordingly, when a viewer sees the light reflected by the screen forming the projection surface, decay of the polarization state can be restricted. As a result, crosstalk between the left eye image and the right eye image can be decreased.

The retardation is expressed as Δnd, where Δn is the difference between the refractive index in the fast axis direction and the refractive index in the slow axis direction and d is the thickness of the waveplate. The phase difference σ of the light caused by the waveplate is expressed as σ=2πΔnd/λ, where λ is the wavelength of the light passing through the waveplate.

### First Embodiment

### Projection Image Display Apparatus

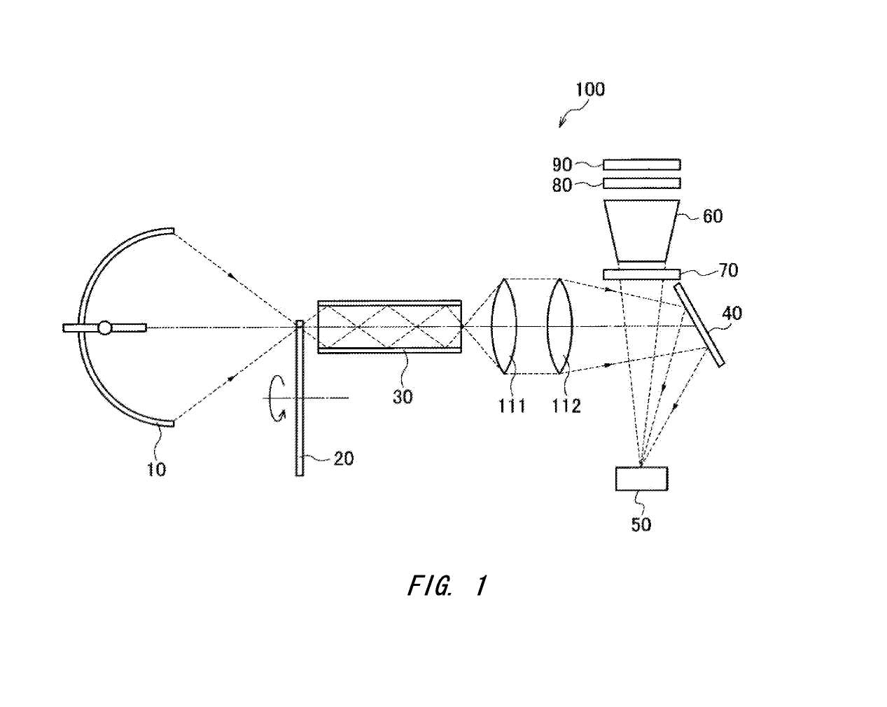

The following describes a projection image display apparatus according to a first embodiment, with reference to the drawings. FIG. 1 shows the projection image display apparatus 100 according to the first embodiment. The first embodiment describes an example in which red component light R, green component light G, and blue component light B are used.

As shown in FIG. 1, the projection image display apparatus 100 includes a light source 10, a color wheel 20, a rod integrator 30, a reflective mirror 40, a DMD 50, a projection unit 60, a polarizing plate 70, a liquid crystal element 80, and a waveplate 90. The projection image display apparatus 100 includes the necessary lens group (lenses 111 and 112).

The light source 10 is a UHP lamp or the like that emits white light. The white light emitted by the light source 10 includes at least red component light R, green component light G, and blue component light B.

The light source 10 includes a reflector shaped as an oval. The reflector has a first focal point and a second focal point that is closer to the color wheel 20 than the first focal point. The first focal point is the point at which the white light is emitted. The second focal point is provided near the color wheel 20, which is described further below. The white light emitted from the light source 10 is focused near the color wheel 20 described further below.

The color wheel 20 is formed to rotate around a rotational axis X, which is parallel to the optical axis of the light source 10. The color wheel 20 is shaped as a circular lid, and is formed by a transparent component such as a glass plate.

The color wheel 20 includes a red region, a green region, and a blue region. The red region is a color filter that passes only the red component light R. Similarly, the green region is a color filter that passes only the green component light G, and the blue region is a color filter that passes only the blue component light B.

In addition to the red region, green region, and blue region, the color wheel 20 may include a region that passes only a certain color component light other that the red component light R, the blue component light B, and the green component light G, e.g. a region that passes only white component light, yellow component light, cyan component light, or magenta component light.

The white light emitted from the light source 10 is focused near the transparent component forming the color wheel 20. In other words, the transparent component forming the color wheel 20 is arranged near the second focal point described above. As a result, the color wheel 20 can be miniaturized.

The rotational axis X need not be the optical axis of the light source 10, and may instead be at an angle relative to the optical axis of the light source 10. For example, the lid surface of the color wheel 20 may be at an angle of 45° relative to the optical axis of the light source 10. In this case, the color wheel 20 may be a reflective color wheel, instead of a transparent color wheel.

The rod integrator 30 is a solid rod formed by a transparent component such as glass. The rod integrator 30 causes the light incident thereto to be uniform. The rod integrator 30 may be a hollow rod having a mirror surface on the inner wall thereof.

The reflective mirror 40 reflects the light emitted from the rod integrator 30 toward the DMD 50.

The DMD 50 is a display element formed by a plurality of miniature mirrors. The miniature mirrors are movable. Basically, each miniature mirror corresponds to one pixel. By changing the angle of each miniature mirror, the DMD 50 switches whether or not the light is reflected toward the projection unit 60.

The projection unit 60 projects the light reflected by the miniature mirrors of the DMD 50, i.e. image light, onto the projection surface (not shown).

The polarizing plate 70 is an optical element that aligns the polarization of the light emitted from the light source 10. Specifically, the polarizing plate 70 passes only a component with a prescribed polarization. The component with the prescribed polarization is a component that is linearly polarized in a prescribed direction, for example. The polarizing plate 70 may be arranged closer to the light source 10 than the liquid crystal element 80, in the optical path of the light emitted from the light source 10. In other words, the polarizing plate 70 may be arranged in front of the liquid crystal element 80.

In the first embodiment, the polarizing plate 70 is arranged in the optical path of the light emitted from the DMD 50, and aligns the polarization of the light emitted from the DMD 50.

The liquid crystal element 80 switches the polarization of the light emitted from the polarizing plate 70 between a first polarization and a second polarization. Specifically, the liquid crystal element 80 switches the polarization of the light emitted from the polarizing plate 70, according to a voltage applied to the liquid crystal element 80. For example, when a voltage is applied to the liquid crystal element 80, the liquid crystal element 80 causes the polarization of the light emitted from the polarizing plate 70 to be aligned with the first polarization. On the other hand, when no voltage is applied to the liquid crystal element 80, the liquid crystal element 80 causes the polarization of the light emitted from the polarizing plate 70 to be aligned with the second polarization.

For example, when the first polarization is vertical linear polarization, the second polarization is horizontal linear polarization. The light emitted from the polarizing plate 70 may be linearly polarized, the first polarization may be left-handed circular polarization (or right-handed circular polarization), and the second polarization may be right-handed circular polarization (or left-handed circular polarization). In this case, voltage is supplied to the liquid crystal element 80 when switching to both the first polarization and the second polarization, but the benefit of reduced crosstalk is still realized.

The present embodiment shows an example in which the light emitted from the liquid crystal element 80 is circularly polarized.

The waveplate 90 restricts decay of the polarization state of the light, and has a plurality of areas with different fast axes or slow axes. In the first embodiment, the waveplate 90 is a half-wave plate.

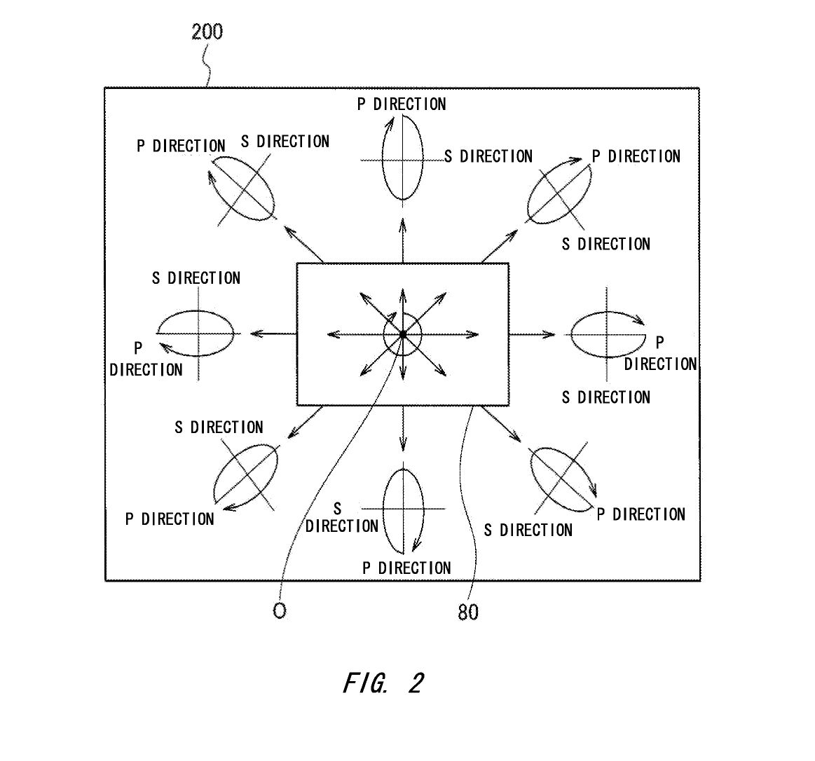

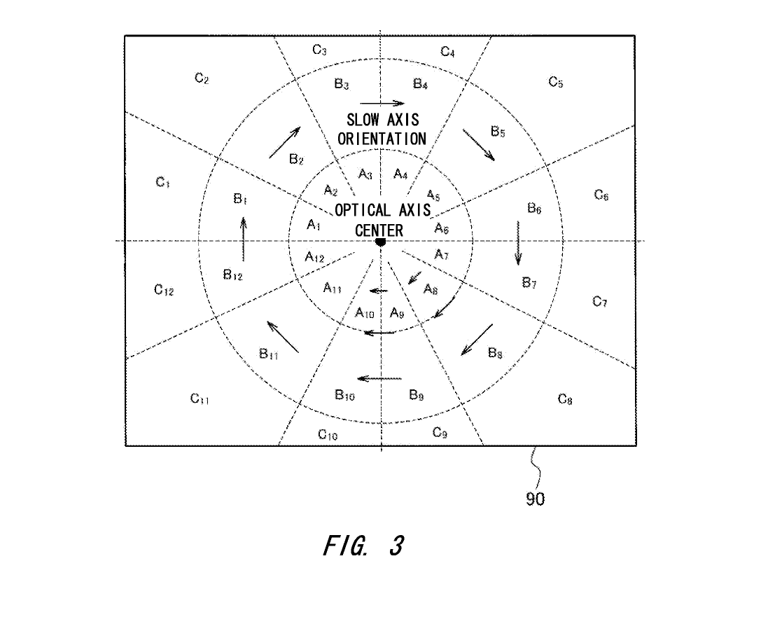

The following describes the configuration of the waveplate 90. First, the polarization state of the light emitted from the screen 200 forming the projection surface will be described, with reference to FIG. 2. The screen 200 may be a silver screen that includes metal microparticles, for example. After this, the configuration of the waveplate 90 will be described, with reference to FIG. 3. In FIG. 2, the liquid crystal element 80 is virtually overlapping the screen 200 in the progression direction of the light emitted from the projection unit 60 (liquid crystal element 80), but does not overlap the waveplate 90. FIG. 3 shows an example in which the light emitted from the liquid crystal element 80 is circularly polarized, and arrows are used to indicate the direction of the slow axis and the magnitude of retardation in the waveplate 90. The arrows shown in FIG. 3 indicate the orientation of the slow axis of the waveplate 90, and the length of each arrow indicates the magnitude of the retardation. The retardation is expressed as Δnd, where Δn is the difference between the refractive index in the fast axis direction and the refractive index in the slow axis direction and d is the thickness of the waveplate. The phase difference σ of the light caused by the waveplate is expressed as σ=2πΔnd/λ, where λ is the wavelength of the light passing through the waveplate.

As shown in FIG. 2, the light emitted from the liquid crystal element 80 progresses radially from a center that is the optical axis center O of the projection unit 60. The direction in which the radial direction centered on the optical axis center O of the projection unit 60 is projected onto the screen 200 is referred to as the P direction, and is also the vibration direction of a P wave. The direction orthogonal to the P direction is referred to as the S direction, and is the vibration direction of an S wave. If the waveplate 90 is not present, the polarization of the light emitted from the liquid crystal element 80 is polarized with a different elliptical polarization in each region, and emitted from the screen 200. Specifically, the light that progresses to the center of the screen 200, i.e. the region near the optical axis center O, is emitted from the screen 200 with a substantially circular polarization. On the other hand, the light that progresses to regions distanced from the optical axis center O is emitted from the screen 200 with an elliptical polarization having a larger P direction component. Accordingly, when the waveplate 90 is not present, the polarization state of the light emitted from the screen 200 is different in each area. As a result, crosstalk occurs.

In contrast to this, in the present embodiment, the light emitted from the liquid crystal element 80 progresses radially to be incident to the waveplate 90. Here, each area of the waveplate 90 has a different fast axis or slow axis, such as shown in FIG. 3. For example, each area of the waveplate 90 has a slow axis in a difference direction, in order to correct the decay of the polarization state. Specifically, as shown in FIG. 3, the waveplate 90 includes areas arranged radially and centered on the optical axis center O of the projection unit 60, e.g. the area A (areas A₁ to A₁₂), area B (areas B₁ to B₁₂), and area C (areas C₁ to C₁₂) shown in FIG. 3. In each of a set of these areas of the waveplate 90, i.e. area 1 (areas A₁, B₁, and C₁) to area 12 (areas A₁₂, B₁₂, and C₁₂) of the waveplate 90, the direction of the slow axis is different, such as shown in FIG. 3. The slow axis intersects the radial direction that extends radially from the optical axis center O of the projection unit 60. For example, the slow axis may be orthogonal to the radial direction that extends radially from the optical axis center O of the projection unit 60. The slow axis has line symmetry with respect to a straight line passing through the optical axis center O of the projection unit 60. Furthermore, the slow axis may have rotational symmetry around the optical axis center O of the projection unit 60.

The thickness of the waveplate 90 through which the light travels is different in each region of the waveplate 90. Accordingly, even if the refractive index difference between the fast axis and the slow axis is the same in a plurality of areas, the retardation, which is a function of the thickness of the waveplate 90, is different in these areas. Specifically, the retardation changes gradually according to the distance from the optical axis center O of the projection unit 60. More specifically, the retardation is greater when the distance from the optical axis center O of the projection unit 60 is greater. The magnitude of the retardation is the same at all points that are the same distance from the optical axis center O of the projection unit 60. The retardation may be made different in each area by having a different refractive index difference between the fast axis and slow axis in each area.

As a result, the polarization state of the light reaching the screen 200 can be made substantially the same in each region. Specifically, the light reaching the region near the center of the screen 200 and the light reaching the region near the edges of the screen 200 can both have substantially the same polarization state after being reflected by the screen 200.

In other words, the decay of the polarization state of the light reflected by the screen 200 can be substantially restricted in each area. As a result, the polarization state of the light reflected by the screen 200 and seen by the viewer can be made substantially uniform over the screen, thereby reducing crosstalk.

It should be noted that the viewer wears polarization glasses corresponding to the type of the first polarization and second polarization, and views the stereoscopic image through these polarization glasses.

### Operation and Effect

In the first embodiment, the waveplate 90 provided between the liquid crystal element 80 and the projection surface has different fast axes or slow axes, e.g. fast axes and slow axes with different direction, or different retardation in each of a plurality of areas. Accordingly, when a viewer sees the light reflected by the screen forming the projection surface, decay of the polarization state can be restricted. As a result, crosstalk between the left eye image and the right eye image can be decreased.

### Practical Example

The following describes a projection image display apparatus 100 in which the first embodiment is implemented.

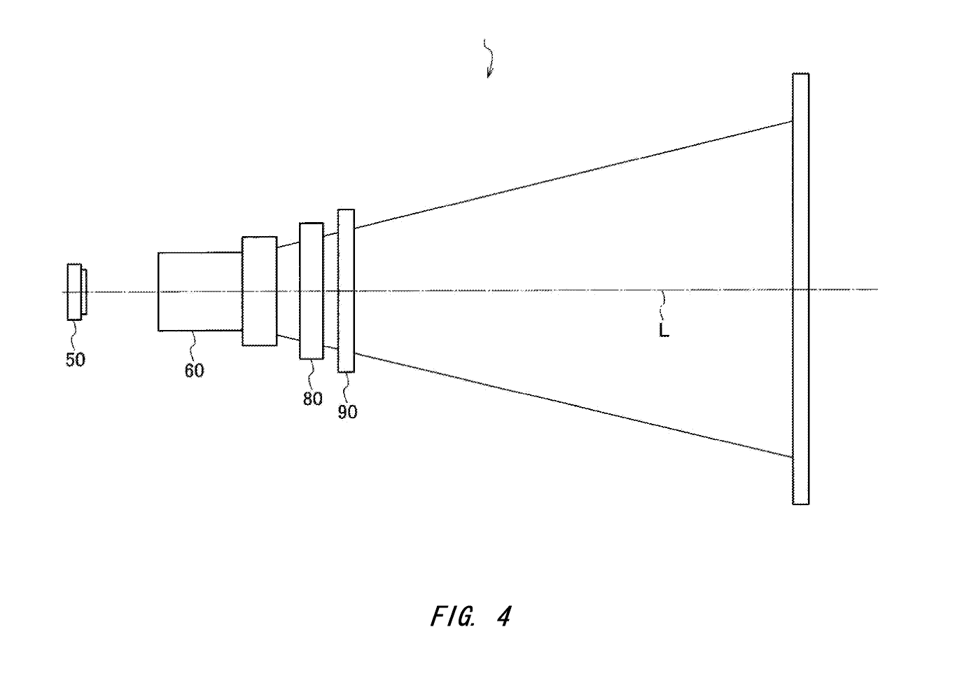

The projection image display apparatus 100 may be a front projection type projector, such as shown in FIG. 4. In this case, the DMD 50 is arranged such that the center of the DMD 50 is on the optical axis L of the projection unit 60.

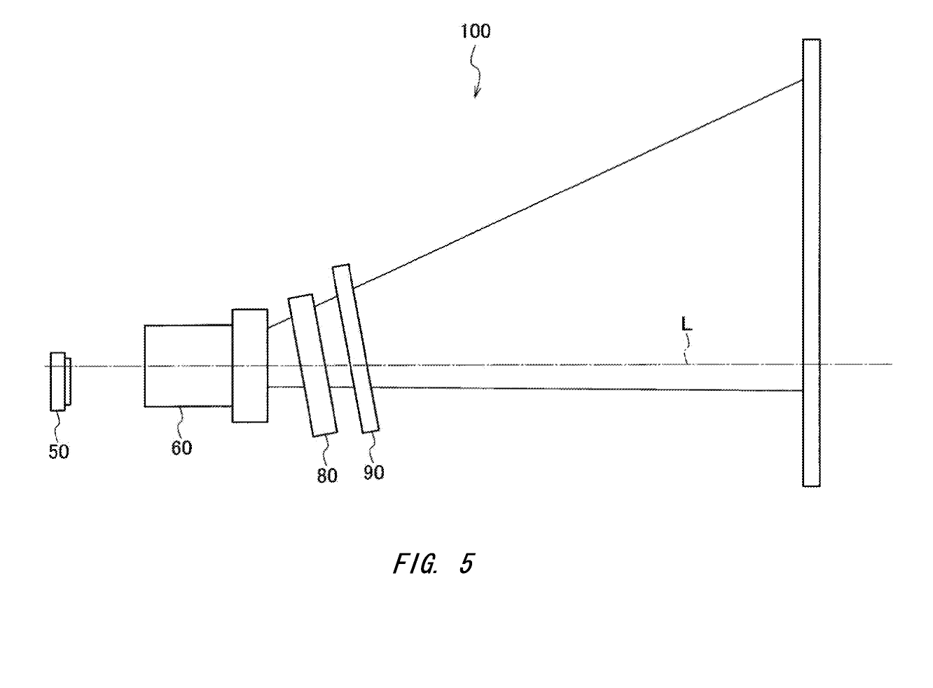

The projection image display apparatus 100 may be a front projection type projector with a short focal length, such as shown in FIG. 5. In this case, the DMD 50 is arranged such that the center of the DMD 50 is at a position shifted from the optical axis L of the projection unit 60, e.g. a position that is shifted down from the optical axis L.

The liquid crystal element 80 and the waveplate 90 may be provided in the optical path of the light emitted from the projection unit 60. Accordingly, the liquid crystal element 80 and the waveplate 90 need not be orthogonal to the optical axis L. In other words, the liquid crystal element 80 and the waveplate 90 are inclined relative to a plane that is orthogonal to the optical axis L.

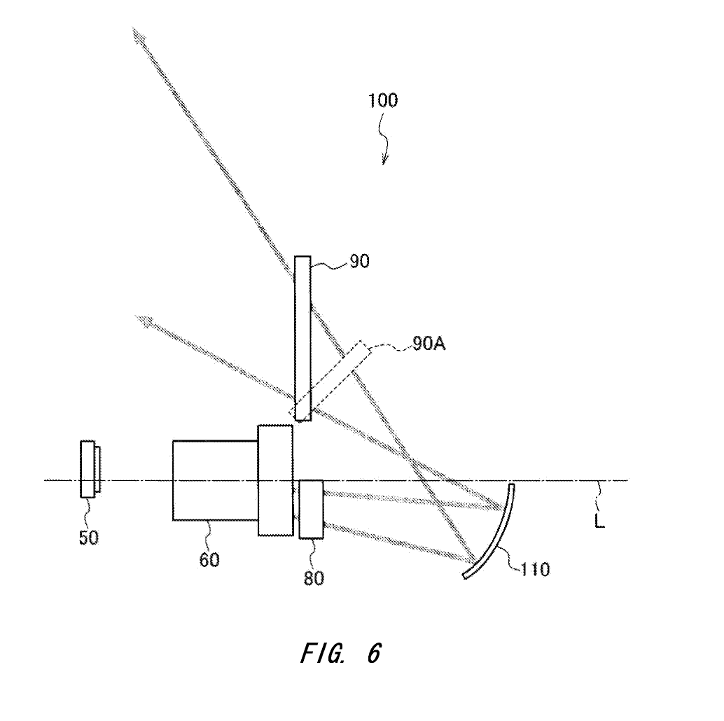

The projection image display apparatus 100 may be a rear projection type projector with a short focal length, as shown in FIG. 6. In this case, the DMD 50 is arranged such that the center of the DMD 50 is at a position shifted from the optical axis L of the projection unit 60, e.g. a position shifted up from the optical axis L. Furthermore, the projection image display apparatus 100 includes a reflective mirror 110 that reflects the light emitted from the projection unit 60 toward the projection surface. For example, the reflective mirror 110 may be a concave mirror of a non-spherical surface.

The liquid crystal element 80 should be provided in the optical path of the light emitted from the projection unit 60. Accordingly, the liquid crystal element 80 is positioned such that the center of the liquid crystal element 80 is at a position shifted from the optical axis L of the projection unit 60, e.g. a position shifted down from the optical axis L. The waveplate 90 is arranged in the optical path of the light reflected by the reflective mirror 110. Accordingly, the waveplate may be orthogonal to the optical axis L as shown by the waveplate 90, or may be oriented to not be orthogonal to the optical axis L, such as shown by the waveplate 90A.

### First Modification

The following describes a first modification of the first embodiment. In the first embodiment, the waveplate 90 is arranged behind the liquid crystal element 80. However, the waveplate 90 need only be arranged between the liquid crystal element 80 and the screen 200 on the optical axis of the light emitted from the liquid crystal element 80.

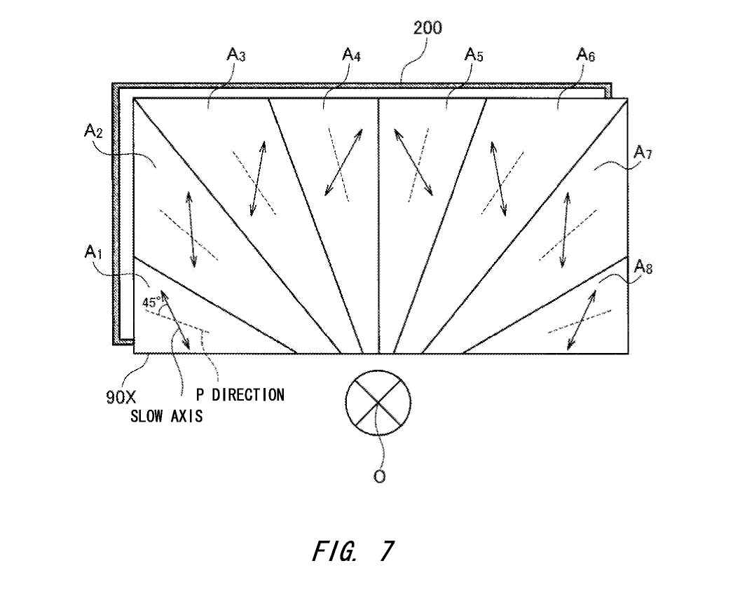

For example, in the first modification, the waveplate 90X is attached to the screen 200 in place of the waveplate 90, such as shown in FIG. 7. In the first modification, the screen 200 is a silver screen and the projection image display apparatus 100 is a rear projection type projector with a short focal length (see FIG. 6).

The waveplate 90X has a plurality of areas with different slow axes or fast axes in order to correct the decay of the polarization state, in the same manner as the waveplate 90. In the first modification, the light that is incident to the screen 200 and the light reflected by the screen 200 are passed by the waveplate 90X. In other words, since the light passes through the waveplate 90X twice, the waveplate 90X is a quarter-wave plate.

Specifically, the slow axis of the waveplate 90X is such that the progression direction of the light incident to the waveplate 90X (screen 200) is inclined at an angle of 45° relative to a direction in which the light is projected on the screen 200. The waveplate 90X has a different slow axis in each of a plurality of areas, e.g. areas A₁ to A₈ shown in FIG. 7. Specifically, the slow axis has line symmetry with respect to a straight line passing through the optical axis center O of the projection unit 60.

Although not shown in FIG. 7, the magnitude of the retardation may change gradually according to the distance from the optical axis center O of the projection unit 60, in the same manner as in the first embodiment. Specifically, the retardation may be greater when the distance from the optical axis center O of the projection unit 60 is greater. The retardation magnitude is the same at all points that are the same distance from the optical axis center O of the projection unit 60.

### Other Embodiments

The present invention was described using the above embodiments, but the descriptions and drawings are only a portion of the present invention, and are not intended to limit the invention. It is apparent to anyone skilled in the art that various alterations or improvements can be made to the above embodiments.

The above embodiments are examples in which the plurality of viewpoint images forming the stereoscopic image are a left eye image and a right eye image. However, the present invention is not limited to this. For example, the plurality of viewpoint images forming the stereoscopic image may include three or more viewpoint images.

Although not specifically addressed in the above embodiments, by using a silver screen as the screen forming the projection surface, the polarization state of the light incident to the silver screen can be maintained even when the light is reflected by the silver screen.

The above embodiments use the DMD (Digital Micromirror Device) as the optical modulation element. However, the optical modulation element may instead be a transparent liquid crystal panel or a reflective liquid crystal panel. Furthermore, a plurality of the optical modulation elements may be provided.

The above embodiments use a white light source as the light source. However, the light source may be a solid state light source that individually emits each of the red component light R, the green component light G, and the blue component light B.

In the above embodiments, the polarizing plate 70 is provided to align the polarization of the light emitted from the light source 10. However, if the polarization of the light emitted from the light source is already aligned, then the polarizing plate 70 is unnecessary.

What is claimed is:

1. A projection image display apparatus that displays a stereoscopic image and comprises a light source, an optical modulation element that modulates light emitted from the light source, and a projection unit that projects the light modulated by the optical modulation element onto a projection surface, the projection image display apparatus further comprising:
a liquid crystal element that switches polarization of the light emitted from the optical modulation element between a first polarization and a second polarization; and
a waveplate that is provided between the liquid crystal element and the projection surface, wherein
the waveplate includes a plurality of areas having different slow axes or fast axes from each other.

2. The projection image display apparatus according to claim 1, wherein
the slow axes or fast axes have line symmetry with respect to a straight line passing through an optical axis center of the projection unit.

3. The projection image display apparatus according to claim 1, wherein
the slow axes or fast axes have rotational symmetry with respect to a straight line passing through an optical axis center of the projection unit.

4. The projection image display apparatus according to claim 1, wherein
the slow axes or fast axes are orthogonal to a straight line extending radially from an optical axis center of the projection unit.

5. The projection image display apparatus according to claim 1, wherein
retardation of the waveplate changes gradually according to distance from an optical axis center of the projection unit.

6. The projection image display apparatus according to claim 1, wherein
retardation of the waveplate increases gradually according to distance from an optical axis center of the projection unit.

7. A waveplate comprising a plurality of areas having different slow axes or fast axes from each other.
